(19) United States
(12) Patent Application Publication
(10) Pub. No.: US 2020/0202423 A1
(43) Pub. Date: Jun. 25, 2020

(54) Systems and Methods of Determining Account Information

(71) Applicant: Michael Boukadakis, Austin, TX (US)

(72) Inventor: Michael Boukadakis, Austin, TX (US)

(21) Appl. No.: 16/228,626

(22) Filed: Dec. 20, 2018

(51) Int. Cl. G06Q 40/02; H04L 29/06; G06K 9/00; G06K 9/22

(52) U.S. Cl. CPC G06Q 40/02; H04L 63/083; G06F 3/04886; G06K 9/228; G06K 2209/01; G06K 9/00469

(57) ABSTRACT

In some embodiments, a computing system may include a network interface configured to communicate with a network, a memory configured to store account data, and a processor coupled to the network interface and to the memory. The processor may be configured to receive data including an image of a credit card from a device through the network. The processor may be further configured to automatically process the image to determine an account number, retrieve available credit data for the account number from the account data, and send the available credit data to the device through the network.

### FIELD

The present disclosure is generally related to systems, methods, and devices configured to determine account information for a user, where such account information may include an available credit balance.

### BACKGROUND

Conventionally, a user may utilize an application on his or her smartphone or other computing device to access a credit card company's system and to interact with the system to authenticate the user or the user's device and then to access account information associated with the user's account. In some embodiments, the user may be required to enter a user name, a password, a pin number, or any combination thereof.

### SUMMARY

In some embodiments, systems, methods, and devices are described below that may allow a user to determine an available credit balance associated with a credit card based on an image of the credit card and an identifier associated with the computing device, without entering username, password, or pin information. The identifier may include a telephone number, a unique code, or another identifier that is associated with at least one of the user, the computing device, and the application executing on the computing device. In some embodiments, the computing device may display a graphical interface that prompts the user to capture an image of the credit card and submit the data corresponding to the user and the image to a computing system associated with company that issued the credit card. In response to sending the data, the computing device may receive available credit information for the credit card from the computing system and may provide the available credit information to the graphical interface. Other embodiments are also possible.

In some embodiments, a computing system may include a network interface configured to communicate with a network, a memory configured to store account data, and a processor coupled to the network interface and to the memory. The processor may be configured to receive data including an image of a credit card from a device through the network. The processor may be further configured to automatically process the image to determine an account number, retrieve credit account data for the account number from the account data, and send the available balance data to the device through the network.

In other embodiments, a computing device may include a network interface configured to communicate with a network, a touchscreen interface, a camera, and a processor coupled to the network interface, the camera, and the touchscreen interface. The processor may be configured to provide a graphical interface to the touchscreen interface. The graphical interface may include a selectable option accessible by a user to capture an image of a credit card. The processor may be further configured to provide the image and an identifier to a credit card account system through the network in response to capturing the image, receive an available account balance from the credit card account system, and provide the available account balance to the graphical interface.

In still other embodiments, a method may include receiving, at a credit card account system, data from a portable computing device through a network. The data may include an image of a credit card. The method may further include automatically determining, using a processor of the credit card account system, an account number from the image of the credit card. Additionally, the method may include automatically retrieving account data corresponding to the credit card based on the account number from a database of account records using the processor and automatically sending at least a portion of the account data to the portable computing device through the network.

### BRIEF DESCRIPTION OF THE DRAWINGS

FIG. 1 depicts a block diagram of a system configured to determine available credit information based on an image of a credit card, in accordance with certain embodiments of the present disclosure.

FIG. 2 depicts a graphical interface including welcome screen accessible by a user to access account information, in accordance with certain embodiments of the present disclosure.

FIG. 3 depicts a graphical interface including a credit card image capture screen accessible by the user to capture an image of the credit card and to submit data to a computing system associated with an issuer of the credit card, in accordance with certain embodiments of the present disclosure.

FIG. 4 depicts a graphical interface including available credit card balance information received from the computing system associated with the issuer of the credit card, in accordance with certain embodiments of the present disclosure.

FIG. 5 depicts a flow diagram of a method of determining account information based on an image of a credit card from a perspective of a portable computing device, in accordance with certain embodiments of the present disclosure.

FIG. 6 depicts a flow diagram of a method of determining account information based on an image of a credit card from a perspective of a computing system associated with an issuer of the credit card, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

Embodiments of systems, methods and devices are described below that may enable a user to utilize his or her smartphone or other portable computing device to determine an available credit card balance for a particular credit card based on a picture of the credit card. In some embodiments, the user may execute a credit card application associated with a company that issued the credit card and then may interact with a graphical interface of the credit card application to take a picture of the credit card. The credit card application may send data related to the picture (and an identifier associated with the application or with the user's device) to a computing system associated with the issuer of the credit card. In some embodiments, the identifier may be a telephone number associated with the computing device (e.g., smartphone) of the user. In other embodiments, the identifier may be serial number or other unique code assigned to the application, the smartphone, or the user. In response to sending the data, the smartphone or portable computing device may receive available credit card balance data and may display the data within the graphical interface.

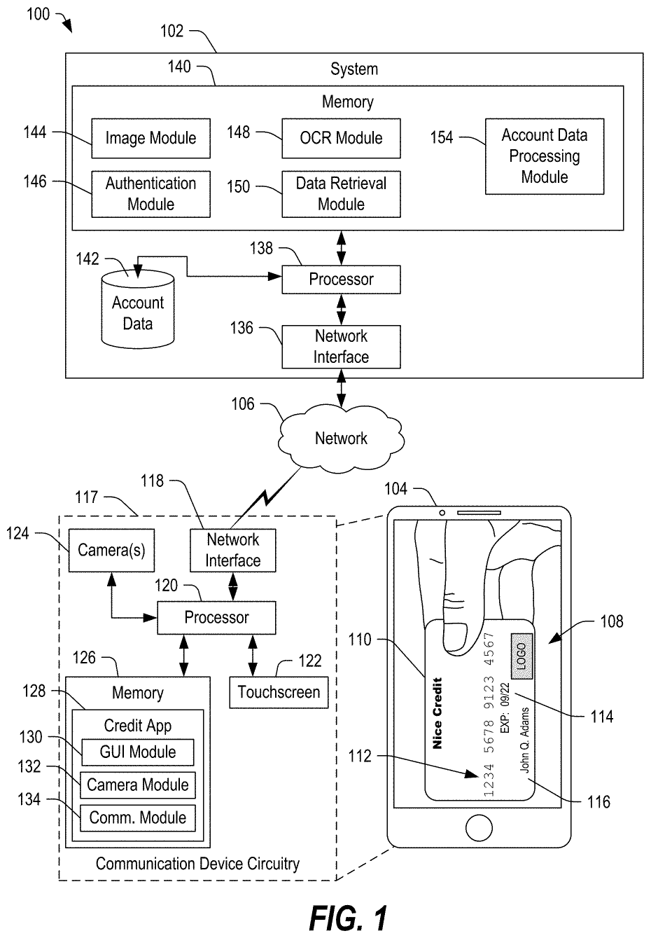

In some embodiments, a computing device may include a network interface, a touchscreen, a camera, and a processor coupled to the network interface, the touchscreen, and the camera. The processor may be configured to provide a graphical interface to the touchscreen to prompt a user to capture an image of a credit card. The processor may control the camera to capture the image. The processor may send data related to the image and an identifier associated with the computing device through a network to a computing system associated with an issuer of a credit card company. In one possible embodiment, the processor may determine text from the image and may encrypt the text and an identifier associated with the computing device to produce the data for sending to the computing system. In another embodiment, the processor may compress the image and encrypt the compressed image and the identifier to produce the data for sending to the computing system. Other embodiments are also possible. In response to sending the data and the identifier, the processor may receive account data associated with the account corresponding to the credit card and may provide at least a portion of the account data to the touchscreen within the graphical interface. One possible example of a system for determining account information is described below with respect to FIG. 1.

FIG. 1 depicts a block diagram of a system 100 configured to determine available credit information based on an image of a credit card, in accordance with certain embodiments of the present disclosure. The system 100 may include a computing system 102 configured to communicate with one or more computing devices, such as a smartphone 104, a laptop computer, a tablet computer, or any combination thereof, through a network 106. The network 106 may include a digital communications network, a cellular network, the Internet, a local area network, or any combination thereof.

The smartphone 104 may include a touchscreen 122 configured to present a graphical interface 108. In this example, the smartphone 104 is displaying a view captured by the camera 124 including a credit card 110 including a credit card number 112, an expiration date, and the card holder's name 116. The smartphone 104 may include circuitry 117.

The circuitry 117 may include a network interface 118 configured to couple the smartphone 104 to the network 106. The circuitry 117 can include a processor 120 coupled to the network interface 118. The circuitry 117 can further include a touchscreen 122 coupled to the processor 120. Additionally, the circuitry 117 may also include one or more cameras 124 coupled to the processor 120. Further, the circuitry 117 can include a memory 126 coupled to the processor 120.

The memory 126 may store data and processor-readable instructions that, when executed, may cause the processor 120 to send data to and receive data from the computing system 102 and to provide a graphical interface to the touchscreen 122. The memory 126 may include a credit application 128 that may be downloaded from a server and that may be associated with a credit card company that issued the credit card 110. The credit application 128 may include a graphical user interface (GUI) module 130 that, when executed, may cause the processor 120 to provide a graphical interface including text data and including selectable options accessible by the user to initiate an account balance retrieval process.

In some embodiments, the credit application 128 may include a camera module 132 that, when executed, may cause the processor 120 to control one or more of the cameras 124 to capture image data including an image of a credit card. The credit application 128 can further include a communication module 134 that, when executed, may cause the processor 120 to send data related to the credit card (as well as data associated with either the credit application 128 or the smartphone 104 to the computing system 102 through the network 106. In some embodiments, the communication module 134 may cause the processor 120 to encrypt the image data, data determined from the image data, the identifier associated with the application 128 or the smartphone 104, or any combination thereof. In some embodiments, the identifier may be a telephone number associated with the computing device (e.g., smartphone 104) of the user. In other embodiments, the identifier may be serial number or other unique code assigned to the application 128, the smartphone 104, or the user.

In some embodiments, each credit application 128 may be coded with a unique identifier that corresponds to the user or that can be combined with authentication information associated with the user to produce a unique identifier, which may be stored in the credit application 128 as an identifier. In some embodiments, the identifier may be communicated together with the credit card information to the computing system 102. Other embodiments are also possible.

The computing system 102 may include a network interface 136 that may be communicatively coupled to the network 106. The computing system 102 may further include a processor 138 coupled to the network interface 136. The computing system 102 can also include a memory 140 coupled to the processor 138. Further, the computing system 102 may include a database 142 of account information, which may be stored within the memory 140 or in a separate memory and which may be coupled to the processor 140.

The memory 140 may store data and instructions that, when executed, may cause the processor 138 to determine account data from the database 142 in response to receiving data from the smartphone 104 or other computing device. The memory 140 may include an image module 144 that, when executed, may cause the processor 138 to receive image data (or data related to the image) from the smartphone 104 through the network 106. The memory 140 may further include an authentication module 146 that, when executed, may cause the processor 138 to verify the identifier associated with the smartphone 104 and the account number associated with the credit card to authenticate the request.

The memory 140 may further include an optical character recognition (OCR) module 148 that, when executed, may cause the processor 138 to determine text, including the card holder's name and account number from received image data. Alternatively, the name and account number information may be received as encrypted data provided directly from the credit application 128 of the smartphone 104. Other embodiments are also possible.

In some embodiments, the OCR module 148 may cause the processor 138 to determine the account number, card holder name, and other information from the image of the credit card, and the determined information may be used in conjunction with the identifier associated with the credit application 128 or the smartphone 104 to authenticate the request using the authentication module 146. Other embodiments are also possible.

The memory 140 may also include a data retrieval module 150 that, when executed, may cause the processor 138 to retrieve account data from the database 142 that corresponds to the account number determined from the received data. The memory 140 may also include an account data processing module 152 that, when executed, may cause the processor 138 to selectively extract the current account balance information from the retrieved account data and to communicate the account balance information to the smartphone 104. Other embodiments are also possible.

It should be appreciated that the OCR operation may be performed at the smartphone 104 or at the computing system 102, depending on the implementation. Further, it should be understood that the communications to the computing system 102 may be encrypted by the smartphone 104 and unencrypted by the computing system 102. The data may include the image captured by the camera, automatically selected portions of the image, text determined from the image, other data, or any combination thereof.

In some embodiments, the computing system 102 may provide at least one of balance data and available credit data to the smartphone 104 without receiving username and password data from the smartphone.

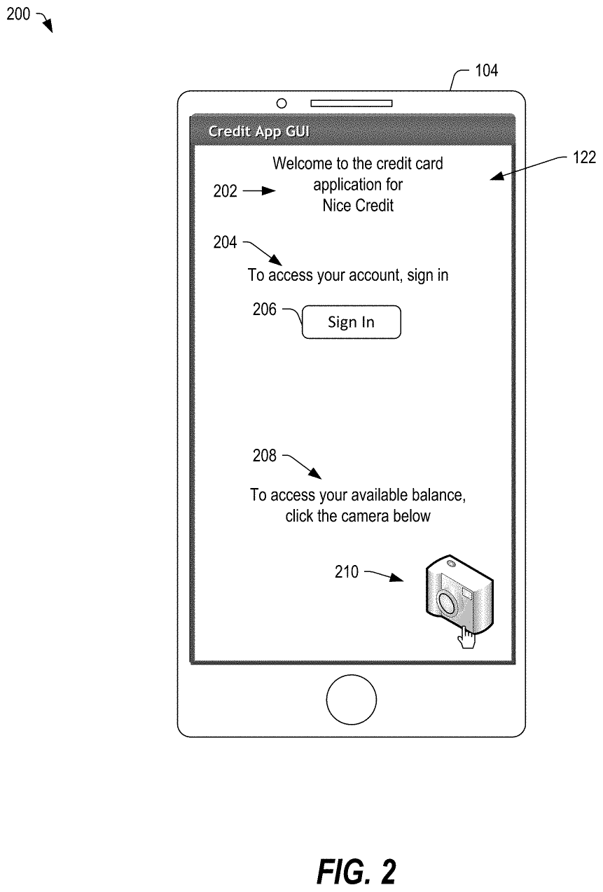

FIG. 2 depicts a graphical interface 200 including welcome screen 202 accessible by a user to access account information, in accordance with certain embodiments of the present disclosure. The graphical interface 200 may be presented on the touchscreen 122 of the smartphone 104. The graphical interface 200 may further include instructions to sign in to access the account, generally indicated at 204, together with a “Sign In” button 206, which may be accessed by the user to log in to the computing system 102 to allow the user to access his or her credit account.

The graphical interface 200 further includes instructions to access the user's available balance, generally indicated at 208. The graphical interface 200 also includes a selectable option 210, which in this example resembles a camera, which can be selected to retrieve the account balance associated with the user's account while bypassing the sign in process.

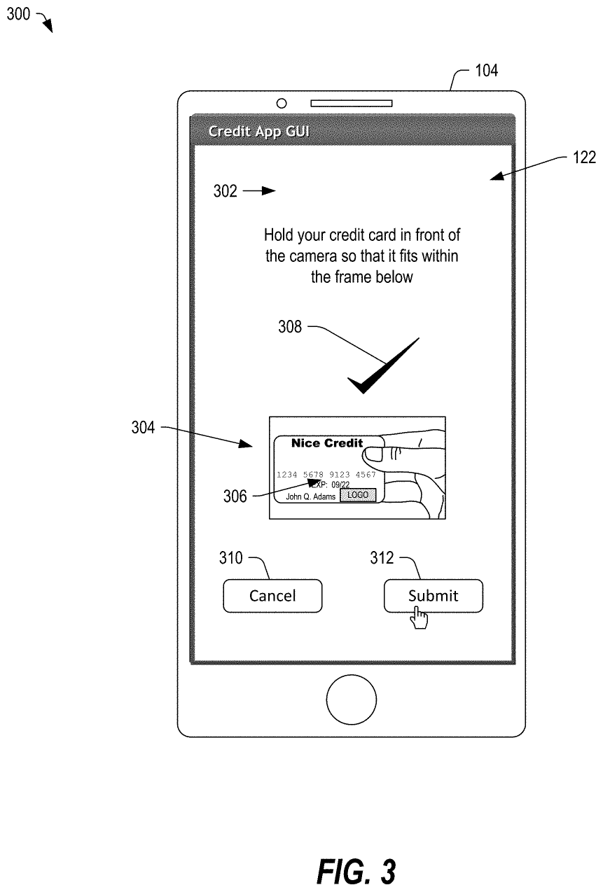

In some examples, instead of the user having to complete a two-factor authentication or having to interact with images to prove that he or she is not a robot in order to complete a login process to be able to view the available balance, the user may select the selectable option 210 to access the information quickly. In response to selecting the selectable option 210, the graphical interface 200 may prompt the user to capture image data as described below with respect to FIG. 3.

FIG. 3 depicts a graphical interface 300 including a credit card image capture screen 302 accessible by the user to capture an image of the credit card and to submit data to a computing system associated with an issuer of the credit card, in accordance with certain embodiments of the present disclosure. The touchscreen 122 of the smartphone 104 may present the graphical interface 300.

In this example, the credit card image capture screen 302 may include instructions for capturing image data related to the credit card by aligning the credit card 306 within a frame 304. Once the image is captured, the graphical interface 300 may include a success indicator, such as the check mark 308. The graphical interface 300 may further include a “Cancel” button 310 and a “Submit” button 312, which may be accessed by the user. In this example, the user may select the “Submit” button 312 to initiate transmission of information related to the credit card 306 and optionally the smartphone 104 or the credit card app 128 to the computing system 104 to determine an available balance associated with the credit card.

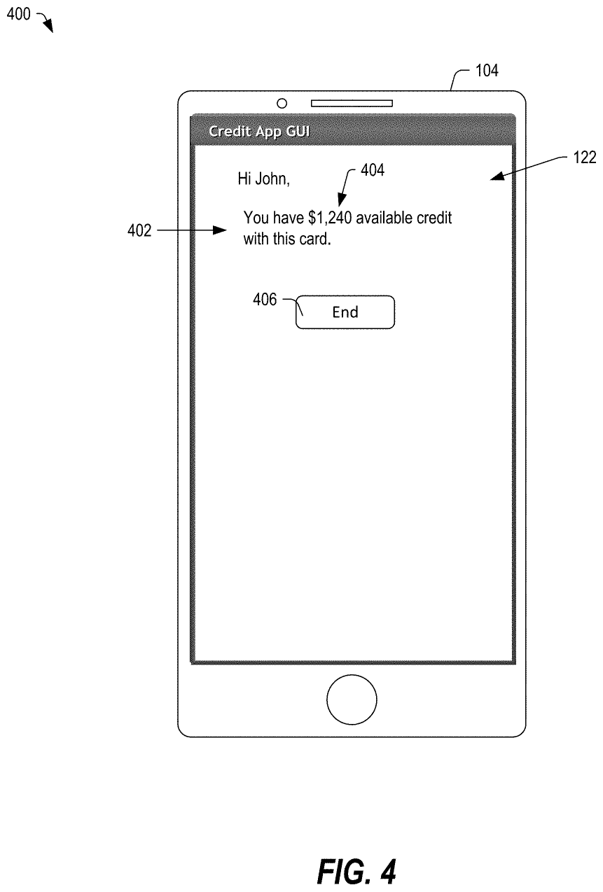

FIG. 4 depicts graphical interface 400 including available credit card balance information received from the computing system associated with the issuer of the credit card, in accordance with certain embodiments of the present disclosure. In this example, the graphical interface 400 may be presented on the touchscreen 122 of the smartphone 104. The graphical interface 400 may include an explanation 402 together with the available credit 404. In some embodiments, the graphical interface 400 may display the current balance and the available credit for the credit card. Additionally, the graphical interface 400 can include an “End” button 406 that, when selected, may close the credit application 128, causing the GUI 400 to close. Other options (such as menu items or other selectable elements) may also be included. Other embodiments are also possible.

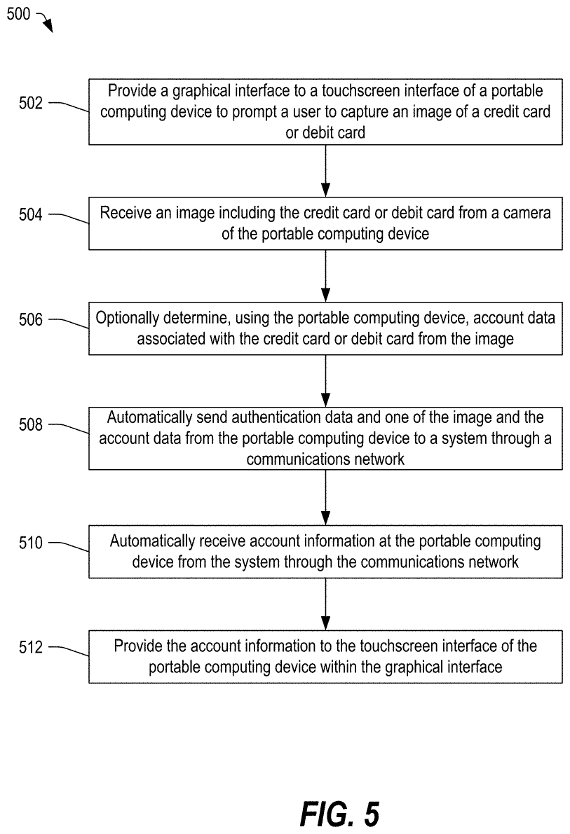

FIG. 5 depicts a flow diagram of a method 500 of determining account information based on an image of a credit card from a perspective of a portable computing device, in accordance with certain embodiments of the present disclosure. At 502, the method 500 can include providing a graphical interface to a touchscreen interface of a portable computing device to prompt a user to capture an image of a credit card (or debit card). In some embodiments, the portable computing device may be a smartphone or another computing device.

At 504, the method 500 can include receiving an image including the credit card or debit card from a camera of the portable computing device. The user may be prompted to hold the card in front of the camera so that the image of the credit card appears within a frame within the graphical interface. Once the credit card is within the frame, the camera may capture the image.

At 506, the method 500 may optionally determine, using the computing device, account data associated with the credit card or debit card from the image. In some embodiments, the computing device (such as the smartphone) may perform OCR on the image data to determine the account data. In other embodiments, the computing device may omit this step and proceed to 508.

At 508, the method 500 can include automatically sending authentication data and one of the image and the account data from the portable computing device to a system through a communications network. The system may be associated with an issuer of the credit card. In some embodiments, the authentication data may include an identifier associated with at least one of the smartphone 104 and the credit application 128. In an example, the identifier may be assigned to the credit application 128 during a download/registration process. Other embodiments are also possible.

In some embodiments, the smartphone may encrypt the data prior to transmission. In lieu of encryption or in addition to encryption, the smartphone may negotiate a secure communications link prior to transfer. Other embodiments are also possible.

At 510, the method 500 may include automatically receiving account information at the portable computing device from the system through the communications network. In a particular example, the account information may include a numerical value associated with the credit card account, where the numerical value represents at least one of a current balance and available credit.

At 512, the method 500 can include providing the account information to the touchscreen interface of the portable computing device within the graphical interface. It should be appreciated that the available credit data may be determined without requiring the user to login. Instead, the user can simply take a picture of his or her credit card and the application retrieves and displays account information associated with the credit card in a few seconds. In some embodiments, the entire process may be completed before a user could otherwise login to his or her account to view the information.

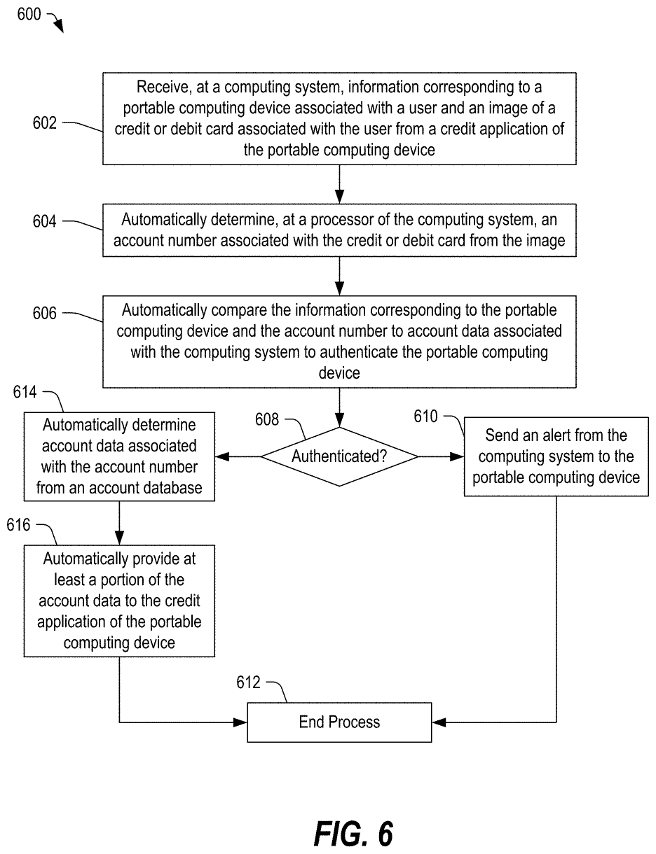

FIG. 6 depicts a flow diagram of a method 600 of determining account information based on an image of a credit card from a perspective of a computing system associated with an issuer of the credit card, in accordance with certain embodiments of the present disclosure. At 602, the method 600 may include receiving, at a computing system, information corresponding to a portable computing device associated with a user and an image of a credit or debit card associated with the user from a credit application of the portable computing device. The user may access the credit application on his or her smartphone and follow the prompts to capture an image of the credit card and send the image and other data to the computing system associated with the issuer of the credit card. The image and the other data may include the information and the image in 602.

At 604, the method 600 can include automatically determining, at a processor of the computing system, an account number associated with the credit or debit card from the image. In some embodiments, the processor may perform an OCR operation on the image to determine the account number. At 606, the method 600 can include automatically comparing the information corresponding to the portable computing device and the account number to account data associated with the computing system to authenticate the portable computing device (and the request for the available balance).

At 608, if the information is not authenticated, the method 600 may advance to 610 to send an alert from the computing system to the portable computing device. The method 600 may then end the process, at 612.

Returning to 608, if the information is authenticated, the method 600 may include automatically determining account data associated with the account number from the account database, at 614. In an example, the processor of the computing system may retrieve the account information from the account database. In some embodiments, the retrieved account information may include the account balance, available credit, other information, or any combination thereof.

At 616, the method 600 may include automatically providing at least a portion of the account data to the credit application of the portable computing device. In some embodiments, the computing system may send only the available balance information to the credit application of the portable computing device. Other embodiments are also possible. The method 600 may then advance to 612 and the process may end.

It should be appreciated that the computing system may be configured to receive an identifier plus image data and may determine the account information based on the identifier and data extracted from the image data. In another embodiment, the computing system may be configured to receive an identifier and account data from the portable computing device of the user and may provide the available account balance information in response thereto. Other embodiments are also possible.

In conjunction with the systems, graphical interfaces, devices, and methods described above with respect to FIGS. 1-6, a system is disclosed that allows a user to determine his or her available credit balance based on a picture of the credit card. In some embodiments, a smartphone or other portable computing device may send the image and an identifier to a computing system associated with the issuer of the credit card and may receive the available balance from the computing system for display within a graphical interface.

In some embodiments, a computing system may receive image data from a smartphone or another computing device. The computing system may automatically determine account data associated with a credit card detected within the image data and may automatically authenticate the source of the image data to verify that the device corresponds to a user associated with the credit card account. The computing system may then determine an available credit account balance associated with the credit card account and may send the balance information to the smartphone or other computing device for display. Other embodiments are also possible.

Although the present invention has been described with reference to preferred embodiments, workers skilled in the art will recognize that changes may be made in form and detail without departing from the scope of the invention.

What is claimed is:

1. A computing system comprising:
a network interface configured to communicate with a network;
a memory configured to store account data; and
a processor coupled to the network interface and to the memory, the processor configured to:
receive data from a device through the network, the data including an image of a credit card;
automatically process the image to determine an account number;
retrieve available credit data for the account number from the account data; and
send the available credit data to the device through the network.

2. The computing system of claim 1, wherein the received data further includes an identifier associated with at least one of the device and an application executing on the device.

3. The computing system of claim 2, wherein the processor is further configured to compare the identifier and the account number to data stored in the account data to authenticate the received data.

4. The computing system of claim 1, wherein the processor is further configured to retrieve account balance data for the account number and to send the account balance data to the device through the network.

5. The computing system of claim 1, wherein the processor processes the image to determine the account number using optical character recognition.

6. The computing system of claim 1, wherein the computing system provides the available credit data to the device without receiving username and password data from the device.

7. A computing device comprising:
a network interface configured to communicate with a network;
a touchscreen interface;
a camera; and
a processor coupled to the network interface, the camera, and the touchscreen interface, the processor configured to:
provide a graphical interface to the touchscreen interface, the graphical interface including a selectable option accessible by a user to capture an image of a credit card;
send the image and an identifier to a credit card account system through the network in response to capturing the image;
receive an available account balance from the credit card account system; and
provide the available account balance to the graphical interface.

8. The computing device of claim 7, wherein the computing device comprises a smartphone.

9. The computing device of claim 7, wherein the processor provides the image and the identifier without a password or user name.

10. The computing device of claim 7, wherein the graphical interface includes a frame displaying optical data captured by the camera and includes instructions to position the credit card in front of the camera such that image data from the camera shows the credit card within the frame.

11. The computing device of claim 7, wherein the identifier comprises a telephone number associated with the computing device.

12. The computing device of claim 7, wherein the identifier comprises a serial number assigned to at least one of the computing device, a credit application executing on the computing device, and the user.

13. The computing device of claim 7, wherein the processor is further configured to encrypt the image data and the identifier before sending the image data and the identifier to the credit card account system.

14. A method comprising:
receiving, at a credit card account system, data from a portable computing device through a network, the data including an image of a credit card;
automatically determining, using a processor of the credit card account system, an account number from the image of the credit card;
automatically retrieving account data corresponding to the credit card based on the account number from a database of account records using the processor; and
automatically sending at least a portion of the account data to the portable computing device through the network.

15. The method of claim 14, wherein automatically retrieving the account data comprises automatically retrieving account balance data and available credit data associated with the credit card.

16. The method of claim 15, wherein automatically sending at least a portion of the account data comprises sending at least one of the account balance data and the available credit data to the computing device.

17. The method of claim 14, wherein automatically determining the account number comprises:
decrypting the image; and
performing optical character recognition on the decrypted image to determine the account number.

18. The method of claim 14, wherein the image is received and the account data is automatically retrieved without receiving a password or user name.

19. The method of claim 14, wherein the data further includes an identifier associated with at least one of a user, the computing device associated with the user, and an application executing on the computing device.

20. The method of claim 14, further comprising comparing the identifier and the account number to data stored in the database of account records to authenticate the received data prior to retrieving the account data.
